(19) United States
(12) Patent Application Publication
(10) Pub. No.: US 2006/0230098 A1
(43) Pub. Date: Oct. 12, 2006

(54) Routing requests to destination application server partitions via universal partition contexts

(75) Inventors: Jinmei Shen, Rochester, MN (US); Hao Wang, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/094,709

(22) Filed: Mar. 30, 2005

(51) Int. Cl. G06F 15/16

(52) U.S. Cl. 709/201

(57) ABSTRACT

A method, apparatus, system, and signal-bearing medium that, in an embodiment, receive a request and an associated universal partition context, determine a destination application server partition based on a context of the request and a partitioning scheme, and route the request and the universal partition context to the destination server partition. The destination application server partition may be further determined based on creating a partition key from the context via the partitioning scheme and by accessing a unified partition configuration that is associated with the destination application server partition via the partition key. The unified partition configuration is determined from the universal partition context. An identification of the server on which the destination application server partition executes and a protocol for communicating with the server are determined from the unified partition configuration, and the request and the universal partition context are routed to the destination server partition based on the identification of the server and the protocol.

### FIELD

An embodiment of the invention generally relates to computers. In particular, an embodiment of the invention generally relates to the routing of requests to application server partitions.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

One of the ways that computer systems have become more powerful is through the use of application partitioning, in which applications are partitioned, or divided, into routable and executable or interpretable parts. Application partitioning can provide many benefits, such as scalability depending on the number of work requests received or the amount of computer systems, processing power, or other resources available to be allocated to the application. Application partitioning can also provide support for multiple and diverse hardware/software configurations, separation of rules and data, the isolation of sensitive, business-critical, or frequently updated processes, ease of upgrade, reuse of components into new applications, use of shared services, or customization of different partitions to different customers, clients, or types of requests. In sum, partitioning can enable applications to be more flexible, more manageable, and less constrained by hardware, software, processes, memory, and other resources.

But, with these potential benefits of application partitioning also come potential problems. Many different types of application partitions are possible, such as database partitions, storage partitions, operating system partitions, processor partitions, memory partitions, network partitions, cache partitions, and user application partitions. A request may go through many different kinds of partitions and invocation points in order to be fulfilled. For example, a request to buy a stock may go through an operating partition, an account partition, a database partition, a stock processing logic application partition, a transaction log partition, and a stock repository partition. All of these partitions may be designed by different companies and different designers using different techniques, which may cause problems for system integrators. Further, misuse or inconsistent use of these different partitioning techniques may cause performance or data integrity problems.

Thus, without a better way to handle partitioning, users will experience difficulty with system integration, performance, and data integrity problems.

### SUMMARY

A method, apparatus, system, and signal-bearing medium are provided that, in an embodiment, receive a request and an associated universal partition context, determine a destination application server partition based on a context of the request and a partitioning scheme, and route the request and the universal partition context to the destination server partition. The destination application server partition may be further determined based on creating a partition key from the context via the partitioning scheme and by accessing a unified partition configuration that is associated with the destination application server partition via the partition key. The unified partition configuration is determined from the universal partition context. An identification of the server on which the destination application server partition executes and a protocol for communicating with the server are determined from the unified partition configuration, and the request and the universal partition context are routed to the destination server partition based on the identification of the server and the protocol.

### BRIEF DESCRIPTION OF THE DRAWINGS

Various embodiments of the present invention are hereinafter described in conjunction with the appended drawings:

FIG. 1 depicts a block diagram of an example system for implementing an embodiment of the invention.

FIG. 2 depicts a block diagram of a universal partition routing engine, according to an embodiment of the invention.

FIG. 3 depicts a block diagram of an example networked system for implementing an embodiment of the invention.

FIG. 4A depicts a block diagram for a universal partition context, according to an embodiment of the invention.

FIG. 4B depicts a block diagram for a unified partition configuration, according to an embodiment of the invention.

FIG. 5 depicts a block diagram of the flow of requests and universal partitions contexts between application server partitions, according to an embodiment of the invention.

FIG. 6 depicts a flowchart of example processing for a universal partition routing engine, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

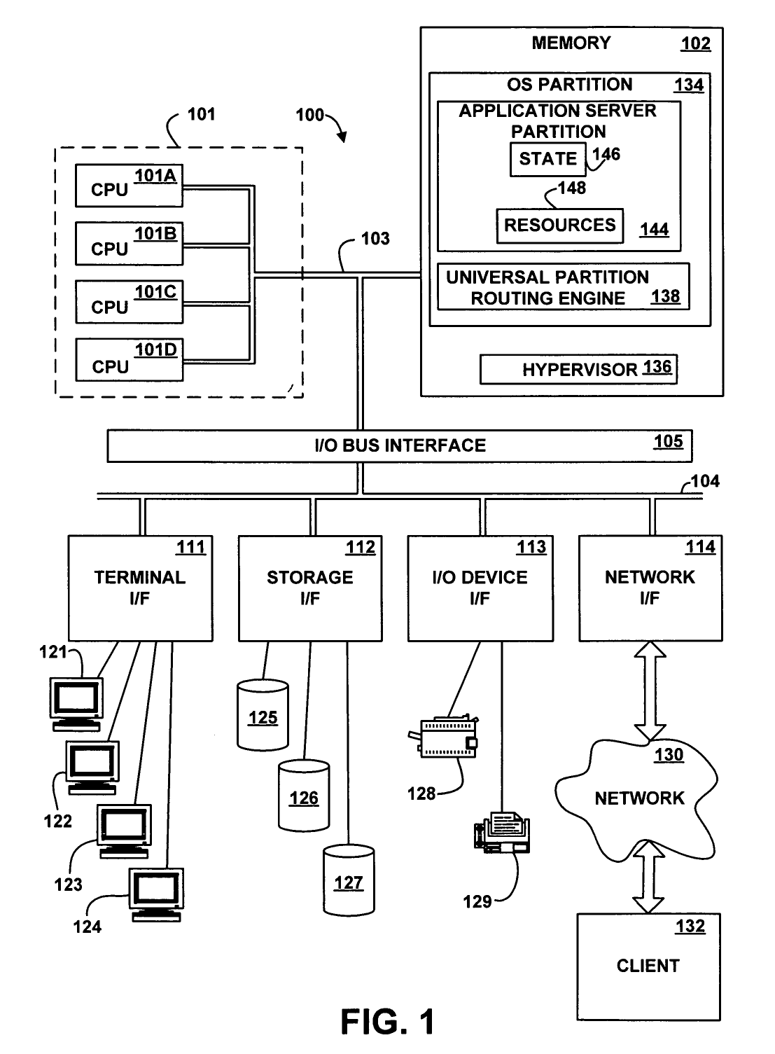

Referring to the Drawings, wherein like numbers denote like parts throughout the several views, FIG. 1 depicts a high-level block diagram representation of a computer system 100 connected via a network 130 to a client 132, according to an embodiment of the present invention. The terms “computer system” and “client” are used for convenience only, any appropriate electronic devices may be used, in various embodiments the computer system 100 may operate as either a client or a server, and a computer system or electronic device that operates as a client in one context may operate as a server in another context. The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 102 is illustrated as containing the primary software components and resources utilized in implementing a logically-partitioned computing environment on the computer 100, including a plurality of logical operating system partitions 134 managed by a partition manager or hypervisor 136. Although the operating system partitions 134 and the hypervisor 136 are illustrated as being contained within the memory 102 in the computer system 100, in other embodiments some or all of them may be on different computer systems and may be accessed remotely, e.g., via the network 130. Further, the computer system 100 may use virtual addressing mechanisms that allow the programs of the computer system 100 to behave as if they only have access to a large, single storage entity instead of access to multiple, smaller storage entities. Thus, while the operating system partitions 134 and the hypervisor 136 are illustrated as residing in the memory 102 in the computer 100, these elements are not necessarily all completely contained in the same storage device, or in the same computer, at the same time.

Each of the logical operating system partitions 134 utilizes an unillustrated operating system, which controls the primary operations of the logical operating system partition 134 in the same manner as the operating system of a non-partitioned computer. For example, each operating system may be implemented using the i5OS operating system available from International Business Machines Corporation, but in other embodiments the operating system may be Linux, AIX, UNIX, Microsoft Windows, or any appropriate operating system. Also, some or all of the operating systems may be the same or different from each other. Any number of logical operating system partitions 134 may be supported as is well known in the art, and the number of the logical operating system partitions 134 resident at any time in the computer 100 may change dynamically as the logical operating system partitions 134 are added or removed from the computer 100.

Each of the logical operating system partitions 134 executes in a separate, or independent, memory space, and thus each logical operating system partition 134 acts much the same as an independent, non-partitioned computer from the perspective of each application server partition 144 that executes in each such logical operating system partition 134. As such, applications, e.g., the application server partitions 144, typically do not require any special configuration for use in a partitioned environment. Given the nature of the logical operating system partitions 134 as separate virtual computers, it may be desirable to support inter-partition communication to permit the logical partitions to communicate with one another as if the logical partitions were on separate physical machines. Although the logical operating system partitions 134 are illustrated as operating as virtual computers within the computer 100, in another embodiment, one of the logical operating system partitions 134 may operate as the entire computer, or as a group of computers, such as one or more servers connected via the network 130.

In some embodiments, it may be desirable to support an unillustrated virtual local area network (LAN) adapter associated with the hypervisor 136 to permit the logical operating system partitions 134 to communicate with one another via a networking protocol such as the Ethernet protocol. In another embodiment, the virtual network adapter may bridge to a physical adapter, such as the network interface adapter 114. Other manners of supporting communication between partitions may also be supported consistent with embodiments of the invention.

Although the hypervisor 136 is illustrated as being within the memory 102, in other embodiments, all or a portion of the hypervisor 136 may be implemented in firmware or hardware. The hypervisor 136 may perform both low-level partition management functions, such as page table management and may also perform higher-level partition management functions, such as creating and deleting partitions, concurrent I/O maintenance, allocating processors, memory and other hardware or software resources to the various operating system partitions 134. In another embodiment, the hypervisor 136 is optional, not present, or not used, the operating system partitions 134 may also not be present or not used, and the application server partitions 144 may exist independently without the benefit of an operating system partition.

The hypervisor 136 statically and/or dynamically allocates to each logical operating system partition 134 a portion of the available resources in computer 100. For example, each logical operating system partition 134 may be allocated one or more of the processors 101 and/or one or more hardware threads, as well as a portion of the available memory space. The logical operating system partitions 134 can share specific software and/or hardware resources such as the processors 101, such that a given resource may be utilized by more than one logical partition. In the alternative, software and hardware resources can be allocated to only one logical operating system partition 134 at a time. Additional resources, e.g., mass storage, backup storage, user input, network connections, and the I/O adapters therefor, are typically allocated to one or more of the logical operating system partitions 134. Resources may be allocated in a number of manners, e.g., on a bus-by-bus basis, or on a resource-by-resource basis, with multiple logical partitions sharing resources on the same bus. Some resources may even be allocated to multiple logical partitions at a time. The resources identified herein are examples only, and any appropriate resource capable of being allocated may be used.

Each operating system partition 134 includes one or more application server partitions 144 and a universal partition routing engine 138. Each application server partition 144 is an independent routable unit of an application. In various embodiments, the application server partition 144 may be a database partition, a storage partition, an operating system partition, a processor partition, a memory partitions, a network partitions, a cache partition, a user partition, or any other type of partition.

Each application server partition 144 includes an application state 146 and application resources 148. The application state 146 represents an object state for the application server partition 144 for a set of the clients 132, and the application resources 148 represent data cache, security data, and/or a database connection for that application server partition 144 and that set of clients 132. Thus, the application state 146 and the application resources 148 customize an application for a particular set of clients 132, but in other embodiments the application server partition 144 need not be customized for clients, and the application state 146 and/or the application resources 148 may be optional, not present, or not used. Applications may be partitioned via a key-based partitioning technique, a hash-based partitioning technique, a combination of key-based partitioning and hash-based partitioning, or via any other appropriate technique.

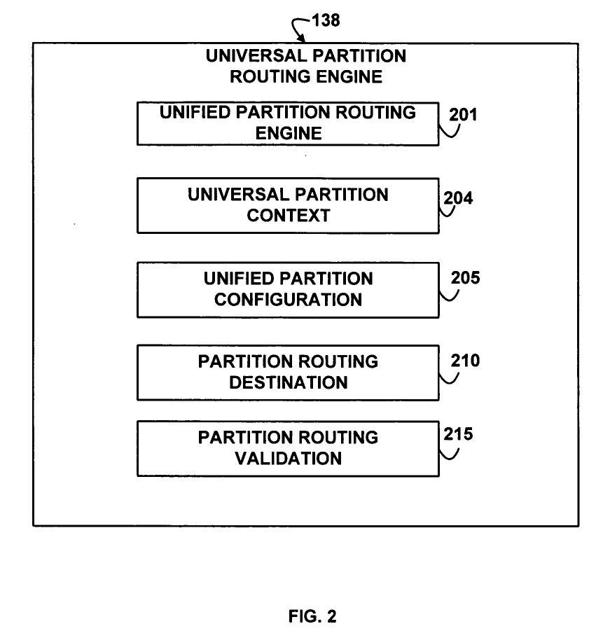

The universal partition routing engine 138 receives requests from the clients 132 and from other application server partitions, determines the correct destination application server partition 144, and routes the requests to the appropriate application server partition 144. The universal partition routing engine 138 is further described below with reference to FIG. 2.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

It should be understood that FIG. 1 is intended to depict the representative major components of the computer system 100 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications medium, such as through a computer or a telephone network, e.g., the network 130, including wireless communications.

Such signal-bearing media, when carrying machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

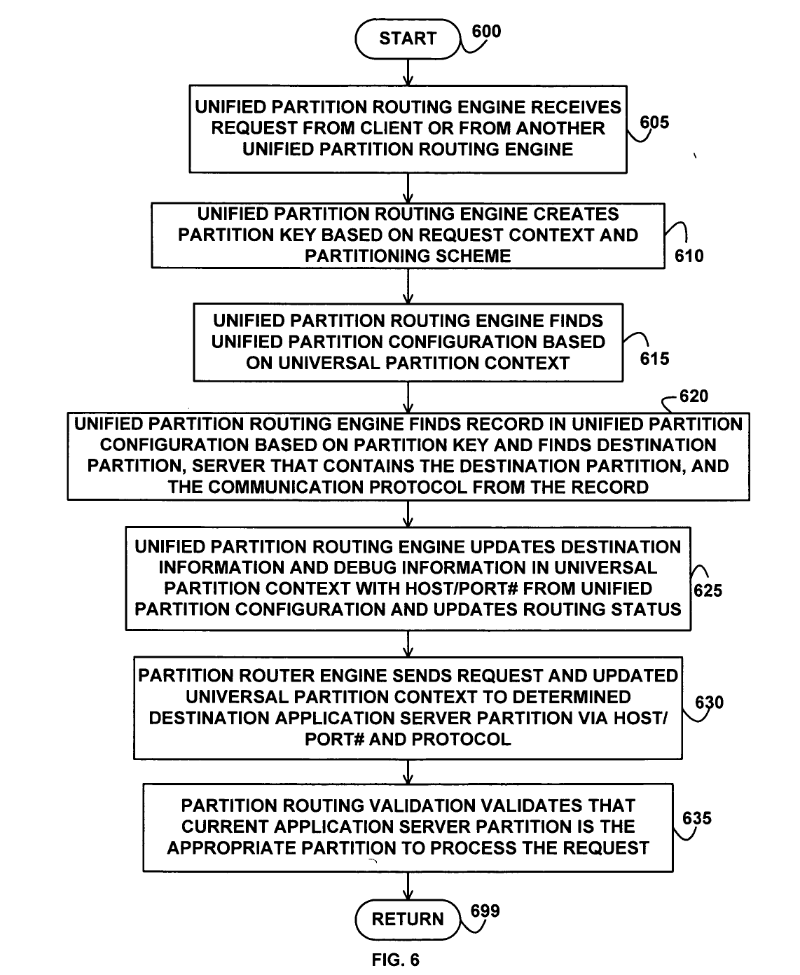

FIG. 2 depicts a block diagram of the universal partition routing engine 138, according to an embodiment of the invention. The universal partition routing engine 138 includes a unified partition routing engine 201, a universal partition context 204, a unified partition configuration 205, a partition routing destination 210, and a partition routing validation 215. The unified partition routing engine 201 receives requests from the clients 132 or from another application server partition 144, determines the partition routing destination 210 (an identification of one of the application server partitions 144) based on the request context, the universal partition context 204, and the unified partition configuration 205, sends the received request and the universal partition context 204 to the determined destination application server partition 144, and updates the universal partition context 204, as further described below with reference to FIG. 6.

In an embodiment, the unified partition routing engine 201 includes instructions capable of executing on the processor 101 or statements capable of being interpreted by instructions executing on the processor 101 to perform the functions as further described below with reference to FIG. 6. In another embodiment, the unified partition routing engine 201 may be implemented in microcode or firmware. In another embodiment, the unified partition routing engine 201 may be implemented in hardware via logic gates and/or other appropriate hardware techniques.

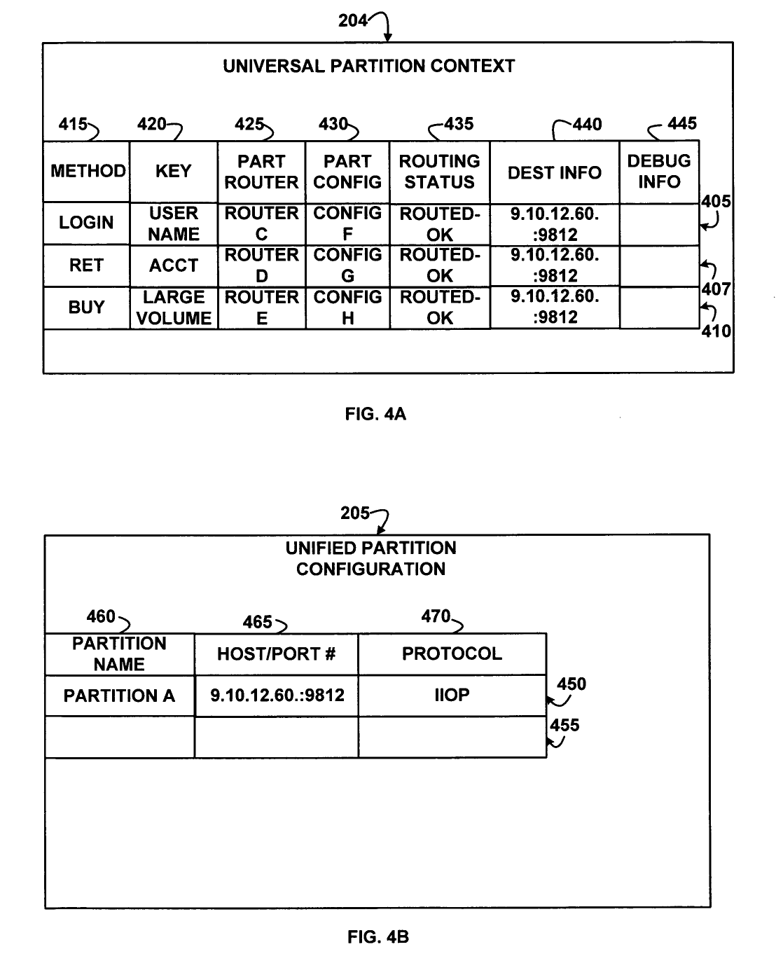

The universal partition context 204 is associated with requests sent between the application server partitions 144. The unified partition routing engine 201 creates the universal partition context 204 in response to receiving a request from the client 132 and sends the universal partition context 204 with the request to the destination application server partition 144. The universal partition context 204 is further described below with reference to FIG. 4A.

The unified partition configuration 205 is associated with each of the application server partitions 144. The unified partition configuration 205 is further described below with reference to FIG. 4B. The partition routing destination 210 identifies the destination application server partition 144 where a request is to be sent. The partition routing validation 215 validates the partition routing destination 210.

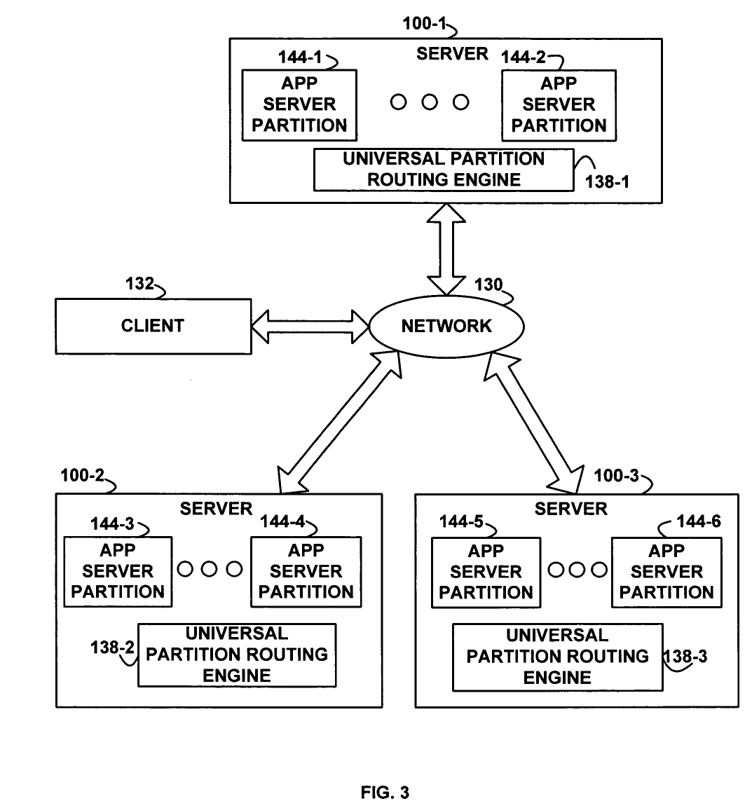

FIG. 3 depicts a block diagram of an example networked system for implementing an embodiment of the invention. The example system includes servers 100-1, 100-2, and 100-3 and the client 132 connected via the network 130. Each of the respective servers 100-1, 100-2, and 100-3 includes respective universal partition routing engines 138-1, 138-2, and 138-3 and respective application server partitions 144-1, 144-2, 144-3, 144-4, 144-5, and 144-6. The servers 100-1, 100-2, and 100-3 are all examples of the computer system 100, as previously described above with reference to FIG. 1. The universal partition routing engines 138-1, 138-2, and 138-3 are all examples of the universal partition routing engine 138, as previously described above with reference to FIG. 1. The application server partitions 144-1, 144-2, 144-3, 144-4, 144-5, and 144-6 are all examples of the application server partition 144, as previously described above with reference to FIG. 1. Although three servers, one client, and one network are illustrated in FIG. 3, in other embodiments any number of each may be present.

FIG. 4A depicts a block diagram for the universal partition context 204, according to an embodiment of the invention. The universal partition context 204 includes data describing various types of requests that the universal partition routing engine 138 may receive from the clients 132 and the application partition servers 144 and information regarding how to route the received requests to the appropriate destination application server partition 144.

The universal partition context 204 includes records 405, 407, and 410, but in other embodiments any number of records within the appropriate data may be present. Each of the records includes a method field 415, a partition key field 420, a partition router field 425, a partition configuration field 430, a routing status field 435, a destination trace information 440, and a debug information field 445.

The method field 415 indicates a type of request, method, or operation that the universal partition routing engine 138 may receive from the client 132 or the application server partition 144. Illustrated in the method field 415 are requests of type “login” and “buy,” but in other embodiments any appropriate type of requests, methods, or operations may be present. The universal partition routing engine 138 creates the records 405, 407, and 410 in the universal partition context 204 with the methods 415 based on the request received from the client 132, and different application server partitions 144 may perform each of the methods 415 in the records 405, 407, and 410. For example, one application server partition may perform the “login” method while another application server partition performs the “buy” method, and both the “login” method and the “buy” method are associated with the same initial request from the client 132. Further, as the partition routing engine 138 routes the request and the universal partition context 204 between different partitions, the partition routing engine 138 moves between the different records in the universal partition context 204 in order to find the next destination application server partition to perform the next method to implement the initial request.

The partition key field 420 specifies a key that may be used to select a row within the unified partition configuration 205. The unified partition routing engine 201 may determine the partition key 420 based on the request context and a partitioning scheme. The request context may include the method or operation of the request and any parameters associated with the request. Examples of partitioning schemes include a key-based partitioning technique, a hash-based partitioning technique, a combination of key-based partitioning and hash-based partitioning, or any other appropriate technique.

Each method may have its own partitioning scheme. For example, the universal partition engine 138 may create three example methods from one initial example request from the client 132: a login request (record 405), a retrieve data request (record 407), and a buy stock request (record 410). The example login request be partitioned by the user's account level, (e.g., gold, silver, and bronze), into three partitions hosted in three servers. The database that holds the data needed by the retrieve data request may be partitioned by geographical location of the user into four partitions: an American user's account database, a European user's account database, an Asian user's account database, and an African user's account database, which may be hosted on different servers. The application that processes the example buy stock request may be partitioned into two partitions, which may be hosted on different servers: one partition for large volume stock purchases (e.g., a volume of stock greater than or equal to 1000 shares) and another partition for processing small volume stock purchases (e.g., a volume of stock less than 1000 shares).

Thus, the universal partition engine 138 may route the login request to the proper partition for login processing, corresponding to that user's particular account level. For example, if the user has a “gold” account, the universal routing engine 138 sends the login request to the “gold” partition. After logging in the user, the universal partition engine 138 sends the example retrieve data request to the appropriate database partition based on the user's geographical location, e.g., the American account partition. After the example retrieve data request is processed by the correct database partition, the universal partition engine 138 sends the buy stock request to the proper application based on the volume of stock indicated in the request.

The partition router field 425 specifies a partition routing engine to use to process the request. If the partition router field 425 is empty or unused, the universal partition routing engine 138 is used to process the request.

The partition configuration field 430 identifies the unified partition configuration 205 that the unified partition routing engine 201 is to use to process the request. The routing status 435 indicates the status of the routing of the request between the application server partitions 144. The destination information 440 identifies the server (via, e.g., a host and port number) that executes the destination application server partition 144 to which the request is to be routed. The debug information field 445 indicates information that may be used to debug the request, such as a trace of the servers and/or partitions where the request has been processed or any other appropriate debug information.

FIG. 4B depicts a block diagram for the unified partition configuration 205, according to an embodiment of the invention. The unified partition configuration 205 includes records 450 and 455, but in other embodiments any number of records with any appropriate data may be present. Each of the records includes a partition name field 460, and host/port # field 465, and a protocol field 470. The partition name field 460 identifies the application server partition 144 associated with the record. The host/port # field 465 identifies the host/port# of the server computer system 100 on which the associated application server partition 144 that is identified by the partition name field 460 executes. The protocol field 470 identifies the protocol for communicating with the application server partition 144 that is identified by the associated partition name field 460. The protocol may be IIOP (Internet Inter-ORB Protocol), HTTP (Hypertext Transport Protocol), JMS (Java Message Service), LDAP (Lightweight Directory Access Protocol), TCP/IP (Transmission Control Protocol/Internet Protocol), or any other appropriate protocol.

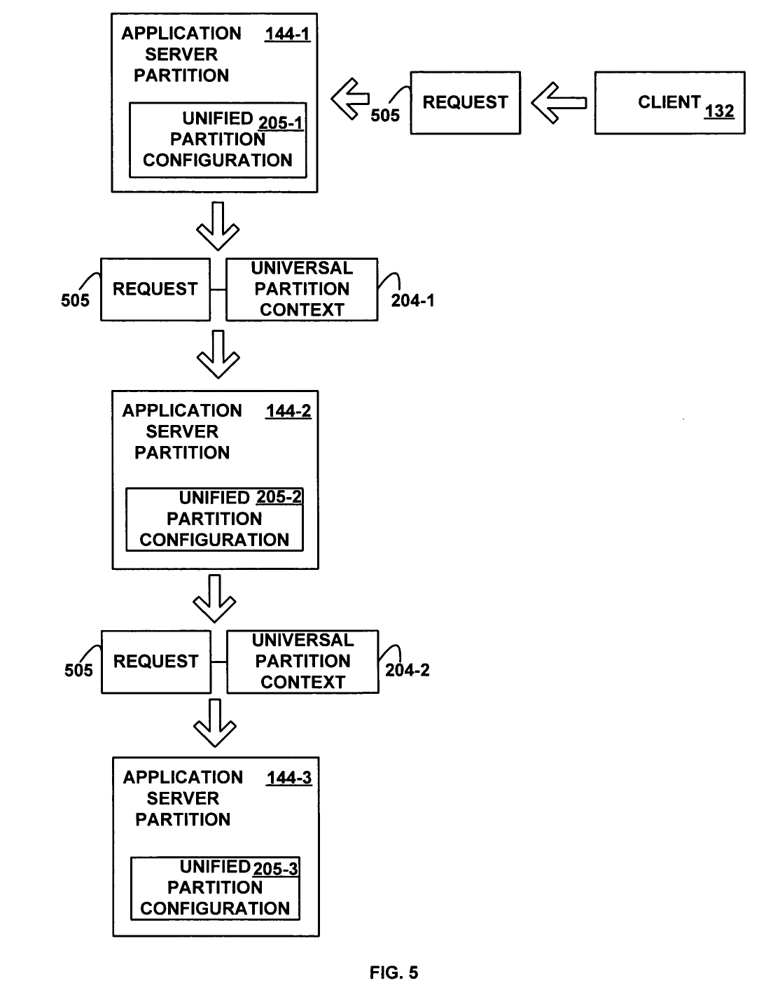

FIG. 5 depicts a block diagram of the flow of requests 505 and universal partition contexts 204-1 and 204-2, according to an embodiment of the invention. The universal partition contexts 204-1 and 204-2 are examples of the universal partition context 204, as previously described above with reference to FIGS. 2 and 4A. Although three application server partitions 144-1, 144-2, and 144-3 are shown, in other embodiments any number may be present.

The request 505 originates from the client 132 and flows to the application server partition 144-1, where the universal partition routing engine 138 creates the universal partition context 204-1 based on the request 505 and the unified partition context 205-1, determines the intended destination application server partition 144-2 based on the request 505, the universal partition context 204-1, and the unified partition configuration 205-1, and routes the request 505 and the universal partition context 204-1 to the application server partition 144-2. At the application server partition 144-2, the universal partition routing engine 138 modifies the universal partition context 204-1 to create the universal partition context 204-2 based on the request 505, the universal partition context 204-1, and the unified partition configuration 205-2, determines the intended destination application server partition 144-3 based on the request 505, the unified partition configuration 205-2, and the universal partition context 204-2, and routes the request 505 and the universal partition context 204-2 to the application server portion 144-3. Although three application server partitions 144-1, 144-2, and 144-3 are shown, in other embodiments any number may be present.

FIG. 6 depicts a flowchart of example processing for the unified partition routing engine 201, according to an embodiment of the invention. Control begins at block 600. Control then continues to block 605 where the unified partition routing engine 201 receives the request 505 from the client 132 or from another unified partition routing engine 201 in a different application server partition 144. If the unified partition routing engine 201 receives the request 505 from another of the application server partitions 144, then the request 505 has an associated universal partition context 204. But, if the unified partition routing engine 201 receives the request from the client 132, the request 505 does not have an associated universal partition context 204, so the unified partition routing engine 201 creates an associated universal partition context 204 based on the request. The unified routing engine 201 determines the appropriate methods to implement the request 505 and sets the methods 415 into the records in the universal partition context 204, in order to implement the method or operation specified by request 505. The various methods 415 in the records of the universal partition context 204 may be processed by different application server partitions 144.

Control then continues to block 610 where the unified partition routing engine 201 creates the partition key 420 based on the request context. Control then continues to block 615 where the unified partition routing engine 201 finds the unified partition configuration 205 specified in the partition configuration field 430 in the universal partition context 204.

Control then continues to block 620 where the unified partition routing engine 201 finds a record in the unified partition configuration 205 based on the created partition key 420. The unified partition routing engine 201 further determines the partition routing destination 210 (a destination application server partition 144) for the request from the partition name field 460 in the selected record of the unified partition configuration 205 and the server that contains the destination partition from the host/port# field 465 in the selected record of the unified partition configuration 205, and the communication protocol to use to communicate with the server from the protocol field 470 of the selected record.

Control then continues to block 625 where the unified partition routing engine 201 sets the determined host/port #465 into the destination information 440 and the debug information 445 and updates the routing status 435 with the status of the routing of the request 505 in the universal partition context 204.

Control then continues to block 630 where the unified partition routing engine 201 sends the received request 505 to the determined destination application server partition 144 based on the partition name 460 at the determined server (host/port #) 465 via the determined communication protocol 470.

Control then continues to block 635 where the partition routing validation 215 determines whether the current application server partition 144 is the appropriate partition to process the request. If the current application server partition 144 is not the appropriate partition, the partition routing validation 215 determines the appropriate application server partition 144 and sends the request 505 and the associated universal partition context 204 to the appropriate application server partition 144. Control then continues to block 699 where the logic of FIG. 6 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
receiving a request and an associated universal partition context, wherein the universal partition context comprises a plurality of identifiers of methods, wherein the methods are capable of being performed by a plurality of application server partitions to process the request;
determining a destination application server partition from among the plurality of application server partitions based on a context of the request and a partitioning scheme; and
routing the request and the universal partition context to the destination server partition.

2. The method of claim 1, further comprising:
determining a unified partition configuration from the universal partition context, wherein the unified partition configuration is associated with the destination application server partition.

3. The method of claim 2, further comprising:
determining an identification of a server on which the destination application server partition executes and a protocol for communicating with the server from the unified partition configuration.

4. The method of claim 3, wherein the routing the request and the universal partition context further comprises:
routing the request and the universal partition context to the destination server partition based on the identification of the server and the protocol.

5. The method of claim 1, wherein the receiving further comprises:
receiving the request and the universal partition context from one of the plurality of application server partitions.

6. The method of claim 2, wherein the determining the destination application server partition further comprises:
creating a partition key from the context via the partitioning scheme; and
determining the destination application server partition, an identification of a server on which the destination application server partition executes, and a protocol for communicating with the server via accessing the unified partition configuration with the partition key.

7. The method of claim 1, wherein the context of the request comprises:
an operation and at least one parameter.

8. A signal-bearing medium encoded with instructions, wherein the instructions when executed comprise:
receiving a request and an associated universal partition context, wherein the universal partition context comprises a plurality of identifiers of methods, wherein the methods are capable of being performed by a plurality of application server partitions to process the request;
determining a destination application server partition from among the plurality of application server partitions based on a context of the request and a partitioning scheme; and
routing the request and the universal partition context to the destination server partition.

9. The signal-bearing medium of claim 8, further comprising:
determining a unified partition configuration from the universal partition context, wherein the unified partition configuration is associated with the destination application server partition.

10. The signal-bearing medium of claim 9, further comprising:
determining an identification of a server on which the destination application server partition executes and a protocol for communicating with the server from the unified partition configuration.

11. The signal-bearing medium of claim 10, wherein the routing the request and the universal partition context further comprises:
routing the request and the universal partition context to the destination server partition based on the identification of the server and the protocol.

12. The signal-bearing medium of claim 8, wherein the receiving further comprises:
receiving the request and the universal partition context from one of the plurality of application server partitions.

13. The signal-bearing medium of claim 9, wherein the determining the destination application server partition further comprises:
creating a partition key from the context via the partitioning scheme; and
determining the destination application server partition, an identification of a server on which the destination application server partition executes, and a protocol for communicating with the server via accessing the unified partition configuration with the partition key.

14. The signal-bearing medium of claim 8, wherein the context of the request comprises:
an operation and at least one parameter.

15. A method for configuring a computer, comprising:
configuring the computer to receive a request;
configuring the computer to create a universal partition context associated with the request;
configuring the computer to set identifications of a plurality of methods based on the request into the universal partition context;
configuring the computer to determine a destination application server partition from among a plurality of application server partitions based on a context of one of the plurality of methods and a partitioning scheme; and
configuring the computer to route the request and the universal partition context to the destination server partition.

16. The method of claim 15, further comprising:
configuring the computer to determine a unified partition configuration from the universal partition context, wherein the unified partition configuration is associated with the destination application server partition.

17. The method of claim 16, further comprising:
configuring the computer to determine an identification of a server on which the destination application server partition executes and a protocol for communicating with the server from the unified partition configuration.

18. The method of claim 17, wherein the configuring the computer to route the request and the universal partition context further comprises:
configuring the computer to route the request and the universal partition context to the destination server partition based on the identification of the server and the protocol.

19. The method of claim 16, wherein the configuring the computer to determine the destination application server partition further comprises:
configuring the computer to create a partition key from the context via the partitioning scheme; and
configuring the computer to determine the destination application server partition, an identification of a server on which the destination application server partition executes, and a protocol for communicating with the server via accessing the unified partition configuration with the partition key.

20. The method of claim 16 wherein the context of the request comprises:
an operation and at least one parameter.
